(19) United States
(12) Patent Application Publication
(10) Pub. No.: US 2012/0010078 A1
(43) Pub. Date: Jan. 12, 2012

(54) Metabolic and nutritional activator for plants

(75) Inventors: Jose Maria Garcia-Mina, Iza (ES); Fabrice Houdusse, Mendigorria (ES); Angel Zamarreño, Eugui (ES); Esther Casanova, Pamplona (ES)

(73) Assignee: Inabonos, S.A., Navarra (ES)

(21) Appl. No.: 13/135,236

(22) Filed: Jun. 29, 2011

Related U.S. Application Data
(62) Division of application No. 11/698,600, filed on Jan. 26, 2007, now abandoned.

(30) Foreign Application Priority Data
Jan. 26, 2006 (ES) 200600178

(51) Int. Cl. A01N 43/38; A01N 27/00; A01N 43/04; A01N 33/02; A01N 37/10; A01P 21/00; A01N 43/00; A01N 43/08; A01N 59/00; A01N 65/00; A01N 41/04; C05F 11/00; A01N 37/02

(52) U.S. Cl. 504/188; 71/27; 504/284; 504/189; 504/357; 504/291; 504/326; 504/324; 504/320; 504/209; 504/299; 504/116.1; 504/350

(57) ABSTRACT

This invention relates to a new formulation activating the absorption of mineral nutrients by plants. Consequently, it has also an effect on the metabolization of these mineral compounds by the plant. These formulations that have been discovered with this property activating nutrient absorption have as main component the compounds represented by general formula 1

CH3—S—CH2—CH₂—CH(OR₁)—COR₂ 1
where R₁ is selected from the group formed by hydrogen, alkyl rests, (preferably methyl or ethyl), and aryl:
while R₂ is selected from the group formed by hydroxyl, amides, alkyl rest esters (preferably methyl or ethyl), or aryl. When the rest is hydroxyl, acid salts with monovalent cations, preferably Na⁺ and K⁺, polyvalent cations, preferably Cu⁺⁺ and Fe⁺⁺⁺, and electropositive organic compounds such as amines (e.g., ethanolamine) are also considered.

### CROSS REFERENCE TO RELATED APPLICATION

This is a divisional of U.S. patent application Ser. No. 11/698,600, filed Jan. 26, 2007 which is incorporated by reference herein.

### DESCRIPTION

The present invention relates to a formulation with the ability to increase significantly the absorption and metabolization of mineral nutrients by plants. The main component of these formulations is 2-hydroxy-4-methyl thiobutanoic (HMTB) acid and its derivatives.

### BRIEF DESCRIPTION OF THE FIGURES

FIG. 1 shows the effect of HMTB on the assimilation of nitrogen (N), magnesium (Mg), and iron (Fe) in a pepper plant. The result is expressed as percent over the control and is calculated from the contents of the elements in the aerial part and the dry matter of the aerial part.

FIG. 2 shows the effect of HMTB on the assimilation of phosphorus (P), potassium (K), and calcium (Ca) in a pepper plant. The result is expressed as percentage over control, and is calculated from the contents of the elements in the aerial part and the dry matter of the aerial part.

FIG. 3 shows the effect of HMTB on the production of dry matter (DM), the number of leaves, and the height of the pepper plants cultured in hydroponic conditions.

FIG. 3 shows the result of the study on the effect of HMTB on the production of total proteins in a pepper plant.

### STATE OF THE ART

One of the factors with the greatest influence in the development of cultures and consequently in the production/quality ratio is the appropriate assimilation of mineral nutrients by the plant and subsequent metabolization. No doubt a product which allows for a greater assimilation of the mineral elements and their better metabolization that is expressed in a greater development of the plant has an unquestionable interest.

Various patents or patent applications can be found in the state of the art (U.S. Pat. No. 4,579,962; U.S. Pat. No. 4,524,077; US2003144547; U.S. Pat. No. 5,972,300), that describe different methods for the preparation of HMTB and analogues of this acid. Its use is also protected in animals, mainly in ruminants, as an agent enhancing milk production (U.S. Pat. No. 6,183,786; US2005059739). However, there is no published information or filed patent on its use in plants as metabolic and nutritional activator.

The methods currently employed to enhance plant development use mechanisms of hormonal nature, as described in the publication by Marschner, H., 1995. Mineral Nutrition of Higher Plants. Academic Press. London. 889 pp; however, to date no formulations have been described to date which increase the assimilation of nutrients by plants and improve their metabolization, that use the properties of 2-hydroxy-4-methyl thiobutanoic acid (HMTB) (isomers D and L), its salts, esters, amides or ethers in position 2.

The inventors have discovered that, surprisingly, using 2-hydroxy-4-methyl-thiobutanoic acid (HMTB) (isomers D and L), its salts, esters, amides or ethers in position 2 in compositions such as those described in the present invention goods results are obtained in the activation of absorption and metabolization of nutrients by plants without requiring the use of compositions stimulating hormonal mechanisms.

### DESCRIPTION OF THE INVENTION

This invention describes new formulations comprising the compound 2-hydroxy-4-methyl thiobutanoic acid (HMTB) (isomers D and L), its salts, esters, amides or ethers in position 2, according to formula 1,

CH3—S—CH2—CH₂—CH(OR₁)—COR₂ 1

where R₁ is selected from the group comprising hydrogen, alkyl rests, ionic groups or radicals (preferably methyl or thyl) and aryl radicals; while R₂ is selected from the group comprising hydroxyl, amides and esters of alkyl (preferably methyl or ethyl) or aryl rests, ionic groups or radicals. When the radical is hydroxyl, acid salts are also considered with monovalent (preferably N⁺ and K⁺) and polyvalent cations (preferably Cu⁺⁺ and Fe⁺⁺⁺) and with electropositive organic compounds, such as amines (for instance, ethanolamine).

It has been discovered that these products have the ability to increase significantly the assimilation of mineral nutrients, particularly nitrogen, magnesium and iron, and the metabolic processes associated with these elements, such as protein synthesis, chlorophyll synthesis and photosynthesis. As a result of this, it has been discovered that these compounds can increase plant development and culture quality. Formula 1 compounds can be included in the metabolic activator at any percentage, though the optimum contents ranges between 1 and 20%.

The metabolic activators described in this invention can contain, in addition to the compounds described in formula 1, one or several compounds with auxin activity or precursors of auxin activity, such as indol acetic acid or tryptophan, or compounds with plant growth regulating activity, including cytokinins, ethylene, brassinosteroids, polyamines, salicylic acid, jasmonic acid, cyclic nucleotides, sucrose, nitric oxide and nitric oxide and abscisic acid precursors or givers. These components of either type can be included in the formulation at any percentage, though the optimum percentage ranges between 1 and 5% in weight.

In addition, the metabolic activator of this invention can contain one or several compounds with the ability to induce hormonal activity in plants such as indol, adenine, adenosine or isopentanol alcohol. The optimum content of these components in the new activator described herein ranges between 1 and 5% in weight, though this content can be increased.

In addition, the activator can include one or several compounds with plant growth stimulating activity such as humic substances, amino acids, seaweed extracts, lignosulfonates, compost plant residue extracts and vinasse or molasses of beetroot and cane. Although these compounds can be included in the formulation at any percentage, the optimum range is between 1 and 5% in weight.

Finally, one or several mineral nutrients can also be included as components of the activator. Therefore, nitrogen can be added, for instance by the addition of ammonia, ammonium nitrate, urea, ammonium sulfate or any salt containing nitrogen: phosphorus, for instance, using any salt of phosphoric, phosphorous, polyphosphoric or pyrophosphoric acid; potassium, for instance using potassium hydroxide, potassium sulfate, potassium chloride, potassium nitrate or potassium carbonate, or any salt containing potassium; magnesium, for instance using magnesium nitrate, magnesium sulfate or any salt containing magnesium; calcium, for instance using calcium nitrate, calcium chloride, and any salt containing calcium; sulfur, for instance using ammonium sulfate, magnesium sulfate or any salt or compound containing sulfur and trace elements, for instance using inorganic salts or organic compounds—chelates—of iron, copper, manganese, zinc, bore, molybdenum, titanium, nickel, silicon and cobalt. The optimum range of these mineral nutrients in the new activator described herein ranges between 5 and 10% in weight, though this content can be higher.

The formulations with activating properties referred to in this invention can be formulated in solid, dissolution or solid-adsorbed liquid state. In solid formulations, the solid is preferably of clay type, such as sepiolite, atapulgite, zeolite, or bentonite; though organic matters can be also used, such as peat; or organic polymers, such as polyacrylamide gels. In the case of liquid formulations, the preferential solvent is water. In both cases, the solid inert or the solvent are added to complete 100% in weight.

For the case of liquid formulations, the mixture of the components at the above described percentages is made in a reactor that can be made up of plastic or stainless steel, with helix stirring. The mixture can be obtained at any temperature, though it is preferably obtained in a range within 20-35° C. The mixture can be also made at any pressure, though the preferred pressure is atmospheric pressure.

In solid formulations, the components are mixed in a blender (any blender could be used, for instance a paddle blender or Lodige) The mixture can be made at any temperature though it is preferably obtained within a range between 20 and 35° C. The mixture can also be performed at any pressure though the preferred pressure is atmospheric pressure. If any component is liquid, it would be applied during the mixing by crushing it over the solid components. The clays play the role of absorbing compound.

The metabolic activator object of this invention can be applied at any concentration range, with an optimum dose between 1 and 100 mg 1⁻¹ (or kg⁻¹). The product can be applied foliarly over the aerial part of the plants or via the root either in solid formulations or in fertirrigation.

### EXAMPLES

To clarify the content of this invention, the following examples are provided that in no case should be considered as invention limiting. Examples 1 to 4 show various metabolic activators according to the present invention. All of them are obtained by directly mixing the components indicated in each case at room temperature and under continuous stirring. Example 5 shows the ability of the composition in example 1.

### Example 1 of Formulation

10% of HMTB acid in liquid formulation

90% water

### Example 2 of Formulation

15% of HMTB acid in liquid formulation

3% potassium hydroxide

82% in water

### Example 3 of Formulation

25% of methyl ester of HMTB acid

75% sepiolite powder

### Example 4 of Formulation

25% of HMTB acid in 88% liquid formulation

5% hydrated iron sulfate (II)

70% water

### Example 5 of Formulation

20% HMTB of 88% liquid formulation

1% indol

5% fulvic acids

74% water

### Example 6 of Formulation

5% HMTB 88% liquid formulation

0.5% indol

10% urea

84.5% sepiolite powder

### Example 7

### Effect of the Formulation of Example 1 on Nutrition and Development of Pepper Plants Cultivated in Hydroponic Conditions

The test performed consisted of the treatment of pepper plants—normally nourished using an appropriate nutrient solution—, with a solution containing HMTB according to the formulation described in example 1. The final dose of HMTB was 50 (D1) and 100 (D2) mg l⁻¹.

The plants were harvested at 4 weeks of starting the test.

The following results were found:
Effect of nutritional activation

Effect on the assimilation of magnesium-nitrogen-iron (Mg—N—Fe)

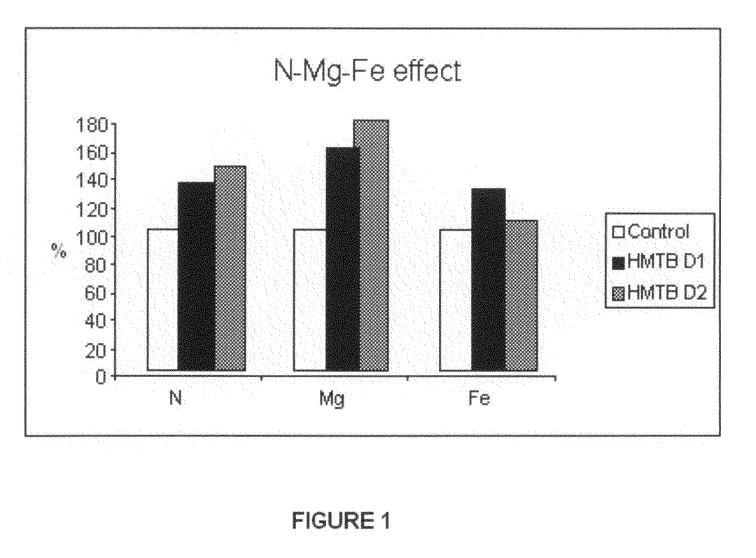

As shown in FIG. 1, highly significant increases were seen in the assimilation of these nutrients expressed for their highest content in the aerial part.
Effect on the assimilation of phosphorus, calcium-potassium (P—Ca—K).

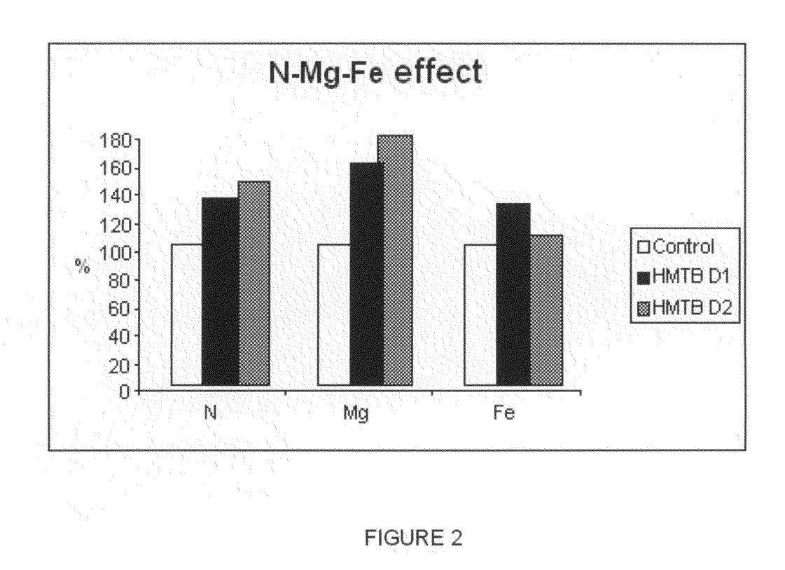

Significant increases were also seen in the assimilation of P, Ca, and K as shown in FIG. 2, though these were lower than in the case of Mg—N—Fe.

Metabolic activation effect

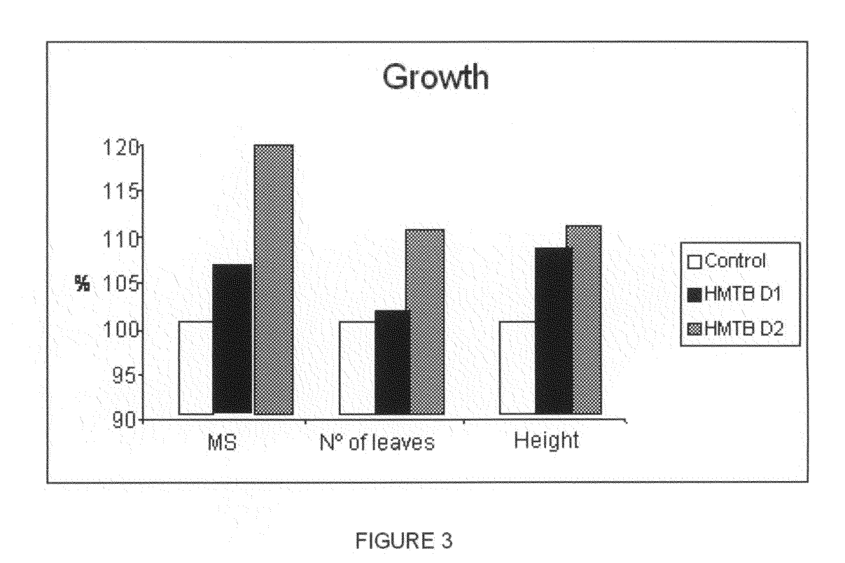

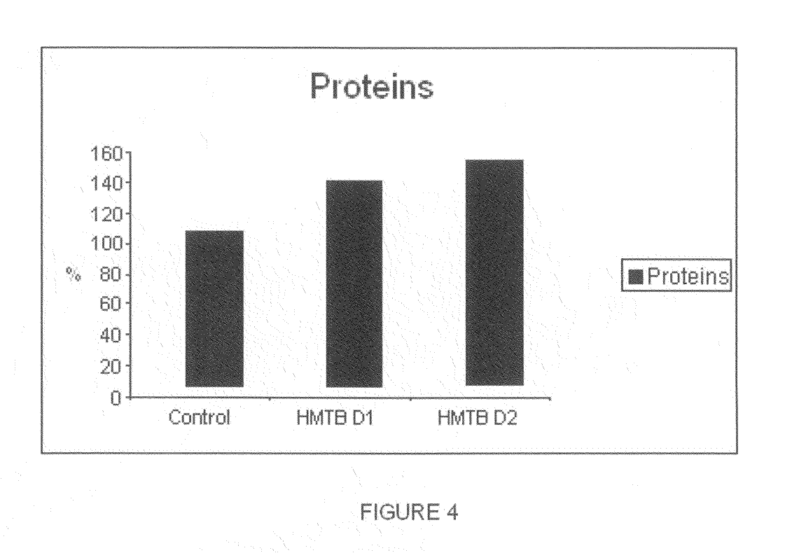

As a result of these nutritional increases, significant increases were seen in the development of plants, as shown in FIG. 3. These effects on development were associated with significant improvements in some associated biochemical processes including the synthesis of total proteins as provided in FIG. 4.

What is claimed and desired to be secured by Letters Patent is as follows:

1. A method for improving assimilation of mineral nutrients and activating the metabolism of the nutrients in plants comprising administering by at least one of via foliarly and over the aerial part of the plants and via the roots of the plants a formulation comprising at least one compound with the general formula:
CH3—S—CH2—CH₂—CH (OR₁)—COR₂
where R₁ is selected from the group consisting of hydrogen, alkyl, and aryl radials and R₂ is selected from the group consisting of hydroxyl, amide, alkyl ester, aryl radicals and, when R₂ is hydroxyl, acid salts thereof with monovalent cations, polyvalent cations, and electropositive organic compounds.

2. The method according to claim 1 wherein:
a) said R₁ is selected from the group consisting of methyl and ethyl radicals.

3. The method according to claim 1 wherein:
a) said R₂ is selected from the group consisting of methyl ester and ethyl ester radicals.

4. The method according to claim 1 wherein:
a) said monovalent cations are selected from the group consisting of Na⁺ and K⁺ and said polyvalent cations are selected from the group consisting of Cu⁺⁺ and Fe⁺⁺⁺.

5. The method according to claim 1 wherein:
a) said electropositive organic compound is an amine radical.

6. The method according to claim 5 wherein:
a) said amine radical is ethanolamine.

7. The method according to claim 1 where the content of the compound in the formulation is within the range of 5-20% by weight.

8. The method according to claim 1 wherein the formulation includes a component selected from the group consisting of
2 hydroxy-4-methylbutanoic acid (CH3—S—CH2—CH2—CH2—CH(OH)—COOH) and salts thereof with monovalent or polyvalent cations.

9. The method according to claim 1 wherein the formulation includes at least one auxin component selected from the group having auxin activity and precursors of compounds having auxin activity.

10. The method according to claim 9 where the concentration of the auxin component is within the range of 1-5% by weight.

11. The method according to claim 9 where the auxin component is selected from the group including indol-acetic acid and trypotophan.

12. The method according to claim 1 wherein the formulation includes at least one growth component having plant growth regulating activity.

13. The method according to claim 12 where the growth component is within the range 1-5% by weight.

14. The method according to claim 12 where the growth component is selected from the group consisting of cytokinins, ethylene, brassinosteroids, polyamines, salicylic acid, jasmonic acid, cyclic nucleotides, sucrose, nitric oxide and precursors of nitric oxide and providers of nitric and absicisic acid.

15. The method according to claim 14 where the growth compound is selected from the group consisting of nitric oxide and nitric oxide precursors.

16. The method according to claim 1 where the compound is formulated with at least one hormonal component with the ability to induce hormonal activity in plants.

17. The method according to claim 16 where the concentration of the hormonal component is within the range of 1-5% by weight.

18. The method according to claim 16 where the hormonal component is selected from the group consisting of indol, adenine, adenosine and isopentanol alcohol.

19. The method according to claim 18 where the hormonal component is indol.

20. The method according to claim 1 including at least one stimulating component with plant growth stimulating activity.

21. The method according to claim 20 where the concentration of the stimulating component is within the range of 1-5% by weight.

22. The method according to claim 20 where the stimulating component is selected from the group consisting of humic substances, amino acids, seaweed extracts, lignosulfonates, compost plant residue extracts, and vinasse and molasses from beet and cane.

23. The method according to claim 1 where the compound also includes at least one mineral nutrient.

24. The method according to claim 23 where the concentration of the mineral nutrient is within the range of 5-10% by weight.

25. The method according to claim 23 where the mineral nutrient is selected from the group consisting of ammonia, ammonium nitrate, urea, ammonium sulfate and any salt containing nitrogen; any salt of phosphoric, phosphorus, polyphosphoric and pyrophosphoric acid; potassium hydroxide, potassium sulfate, potassium chloride, potassium nitrate, potassium carbonate, and any salt containing magnesium; calcium nitrate, calcium chloride and any salt containing calcium; ammonium sulfate, magnesium sulfate and any salt and compound containing sulfur; and inorganic salts of iron, copper, manganese, zinc, molybdenum, titanium, nickel, silicon and cobalt chelates.

26. The method according to claim 1 wherein the formulation is in a state including a liquid state, a solid state and liquid absorbed in an absorbent material.

27. The method according to claim 26 where the absorbent material is selected from the group consisting of clays, organic substances and organic polymers.

28. The method according to claim 26 applied to plants in a dose in a range between 1 and 100 mg of the compound per liter.

29. The method according to claim 1 wherein the formulation includes:
a) an auxin component;
b) a growth component having plant growth regulating activity;
c) a hormonal component having the ability to induce hormonal activity in plants;
d) a stimulating component having plant growth stimulating activity; and
e) a mineral nutrient for plants.
